(19) United States
(12) Patent Application Publication
(10) Pub. No.: US 2002/0185558 A1
(43) Pub. Date: Dec. 12, 2002

(54) Method of milling pharmaceutical preparation

(76) Inventor: Stephen M. Lemanczyk, Syracuse, NY (US)

Correspondence Address: MICHAEL P. WILLIAMS, BOND, SCHOENECK & KING, PLLC, ONE LINCOLN CENTER, SYRACUSE, NY, 13202, US

(21) Appl. No.: 09/879,528

(22) Filed: Jun. 12, 2001

(51) Int. Cl. B02C 19/06

(52) U.S. Cl. 241/5; 241/30

(57) ABSTRACT

An apparatus for the preparation of penicillin G procaine comprising a first vessel containing a suspension that includes particles of penicillin G procaine. A first conduit connects the first vessel to a microfluidizer and the suspension passes through the microfluidizer to a second conduit having a mesh screen. The particles pass through said microfluidizer whereby said particles are reduced in particle size and are delivered by the second conduit to a holding vessel.

### FIELD OF THE INVENTION

The present invention is directed toward an apparatus and method of milling a pharmaceutical preparation and more specifically is directed toward milling particles formed in aqueous suspension.

### BACKGROUND OF THE INVENTION

Pharmaceutical preparations are manufactured and prepared for end use utilizing numerous manufacturing and synthesis methods. Advantageously, some pharmaceuticals can be prepared in aqueous suspensions in situ. One particular pharmaceutical preparation of interest in the present application and well known in the art is penicillin G procaine, which can be produced in situ by the reaction of procaine HCL and potassium penicillin G. The resulting product is an aqueous suspension that contains large particles of penicillin G procaine. However, in order for the penicillin product to be useful to the end user, such as a veterinarian, the particles must be of a suitable particle size that will allow for the easy and efficient application of the pharmaceutical to the patient.

There are many methods available for reducing the particle size of penicillin G procaine. For instance, one known method is to process the preparation using a mill containing glass or plastic beads that break up the agglomerates through mechanical interaction between the beads and preparation within the mill.

Although the known methods of reducing particle size of penicillin G procaine in suspension are effective, the methods are still cumbersome and costly. For instance, in situ preparation of penicillin G procaine can be accomplished in sterile conditions which is very cost effective. In order to process downstream of the in situ preparation, the milling apparatus must be sterile. The introduction of a mill with beads leads to costly measures to insure the sterile condition of the product. In addition, glass or plastic beads can shear thereby adding undesirable foreign matter to the finished product.

### OBJECTS AND SUMMARY OF THE INVENTION

It is therefore an object of the present invention to provide an apparatus for milling a pharmaceutical preparation to a desired particle size.

It is a further object of the present invention to provide an economical apparatus for milling a pharmaceutical preparation.

It is yet another object of the present invention to provide an economical apparatus for the milling of penicillin G procaine that has been produced in situ.

These and other objects are accomplished by providing an apparatus for the preparation of penicillin G procaine comprising a first vessel containing a suspension that includes particles of penicillin G procaine. A first conduit connects the first vessel to a microfluidizer and the suspension passes through the microfluidizer to a second conduit having a mesh screen. The particles pass through the microfluidizer whereby the particles are reduced in size and are delivered by the second conduit to a holding vessel.

### BRIEF DESCRIPTION OF THE DRAWINGS

FIG. 1 is a schematic diagram of the present invention.

### DETAILED DESCRIPTION OF THE INVENTION

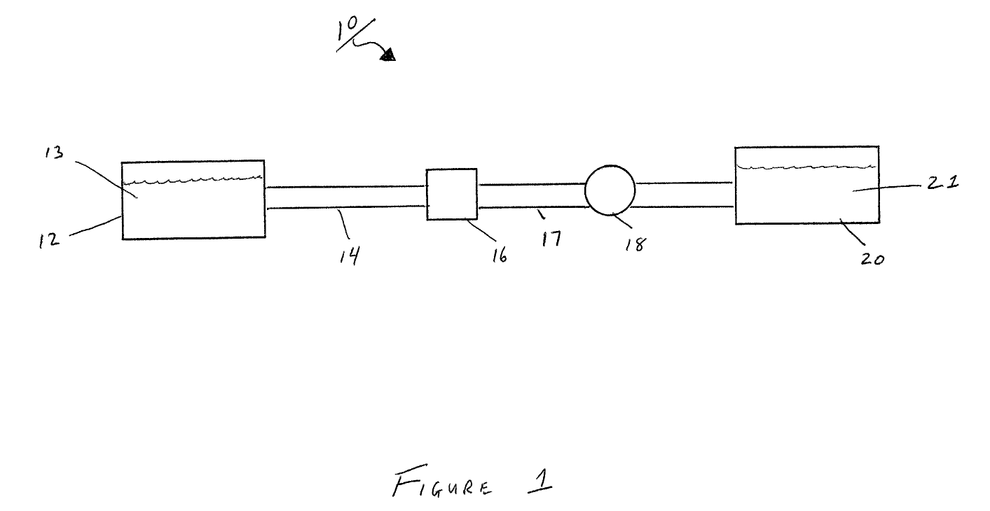

Referring now to FIG. 1, there is shown a schematic of the present invention that includes an apparatus 10 for the milling of a pharmaceutical preparation. The apparatus 10 includes a first vessel 12, typically a stainless steel tank as is known in the art. The vessel 12 contains a pharmaceutical preparation 13 such as a suspension containing penicillin G procaine. The penicillin G procaine is most efficiently produced in situ through the reaction of procaine HCL with potassium penicillin G. This in situ production creates a suspension with particles of penicillin G procaine which have particle sizes that are too large for easy and practical applications by the end users and therefore it is desirable to mill the preparation to a smaller particle size. Typically, the suspension is maintained under sterile conditions at a temperature of about 20 degrees Celsius.

The suspension containing the particles is delivered to a microfluidizer 16 via a conduit 14. The conduit 14 in the preferred embodiment is a 1.5 inch stainless stee; tubing. A microfluidizer, such as those produced by Microfluidics Corporation of Newton, Mass., causes two high pressure fluid streams to interact at ultra high velocity. Shear, impact, and cavitation forces act on the fluid streams to achieve particle reduction with relative uniform particle size distribution. Fluid pressures of microfluidizers can range from 2000 psi to 40,000 psi. In the preferred embodiment, the microfluidizer 16 operates between 15,000 and 20,000 psi with an optimum of approximately 18,000 psi. In the preferred embodiment, the suspension is directed through the microfluidizer 16 at an approximate rate of 4.5 gallons per minute.

After passing through the microfluidizer 16, the suspension is directed through a second conduit 17. Preferably, the second conduit 17 is a stainless steel tube. As is known in the art, mesh screens can be used to control the particle size of material passing therethrough. In the preferred embodiment, a 100 mesh screen 18 that allows particles sizes of 0 to 150 microns to pass through is placed in communication with second conduit 17. Therefore, the microfluidizer 16 reduces the particle size to a degree sufficient to allow the particles to efficiently pass through the mesh screen.

The second conduit 17 moves the suspension to a second vessel 20. The second vessel 20 may work as a holding tank for the finished suspension 21. As is known in the art, the holding tank 20 is manufactured from stainless steel. The finished suspension is a sterile aqueous suspension containing penicillin G procaine with particle sizes ranging from approximately 0 to 150 microns. From the holding tank 20, the finished suspension 21 is moved to a filling operation (not shown) wherein the suspension 21 is placed into packages suitable for sale to end users.

What is claimed:

1. An apparatus for the preparation of penicillin G procaine, said apparatus comprising:
a first vessel containing a first suspension, said first suspension comprising particles of penicillin G procaine;
a first conduit connecting said first vessel to a microfluidizer; and,
a second conduit having a mesh screen, said second conduit connecting said microfluidizer to a second vessel, wherein said particles pass through said microfluidizer whereby said particles are reduced in particle size.

2. The apparatus of claim 1 wherein said particles have a particle size between approximately 0 and 150 microns after passing through said mesh screen.

3. The apparatus of claim 1 wherein said mesh screen comprises a 100 mesh screen.

4. The apparatus of claim 1 wherein said microfluidizer has an operating pressure in the range of 15,000 to 20,000 psi.

5. The apparatus of claim 1 wherein said microfluidizer has an operating pressure of approximately 18,000 psi.

6. A method of preparing a preparation of penicillin G procaine, said method comprising:
supplying a first vessel containing a suspension, said suspension comprising particles of penicillin G procaine;
directing said suspension through a first conduit that connects said first vessel to a microfluidizer; and,
directing said suspension through a microfluidizer and into a second conduit having a filter, said second conduit connecting said microfluidizer to a second vessel, wherein said particles pass through said microfluidizer whereby said particles are reduced in particle size.

7. The method of claim 6 wherein said particles have a particle size between approximately 0 and 150 microns after passing through said mesh screen.

8. The method of claim 6 wherein said filter comprises a 100 mesh screen.

9. The method of claim 6 wherein said microfluidizer has an operating pressure in the range of 15,000 to 20,000 psi.

10. The method of claim 6 wherein said microfluidizer has an operating pressure of approximately 18,000 psi.

11. A method of preparing a preparation of penicillin G procaine, said method comprising:
combining procaine hydrochloride with potassium penicillin G in situ wherein said combination results in a suspension comprising particles of penicillin G procaine;
supplying a first vessel containing said suspension;
directing said suspension through a first conduit that connects said first vessel to a microfluidizer; and,
directing said suspension through a microfluidizer and into a second conduit having a filter, said second conduit connecting said microfluidizer to a second vessel, wherein said particles pass through said microfluidizer whereby said particles are reduced in particle size.

12. The method of claim 11 wherein said particles have a particle size between approximately 0 and 150 microns after passing through said microfluidizer.

13. The method of claim 11 wherein said filter comprises a 100 mesh screen.

14. The method of claim 11 wherein said microfluidizer has an operating pressure in the range of 15,000 to 20,000 psi.

15. The method of claim 11 wherein said microfluidizer has an operating pressure of approximately 18,000 psi.
